(19) United States
(12) Patent Application Publication
(10) Pub. No.: US 2007/0180237 A1
(43) Pub. Date: Aug. 2, 2007

(54) Apparatus and methods for interaction between message groups and encryption methods

(75) Inventors: Anthony Harold Grieco, Raleigh, NC (US); Michael Otto Tjebben, Cary, NC (US)

Correspondence Address: SCHWEGMAN, LUNDBERG, WOESSNER & KLUTH, P.A., P.O. BOX 2938, MINNEAPOLIS, MN, 55402, US

(73) Assignee: Cisco Technology, Inc.

(21) Appl. No.: 11/316,184

(22) Filed: Dec. 22, 2005

(51) Int. Cl. H04L 9/00

(52) U.S. Cl. 713/163

(57) ABSTRACT

A method and apparatus to process an outgoing electronic communication is described. The method may comprise, at a messaging client, retrieving members of a message group together with an encryption mechanism for each of the members, encrypting an outgoing electronic communication using the encryption mechanisms and sending the outgoing encrypted message to each of the members of the message group. In an alternate embodiment, the method may comprise, at a message group server, distributing a package to one or more messaging clients, the package containing members of a message group together with at least one encryption mechanism for each of the members of the message group. In an example embodiment, a user sends an email to an email alias through their email client. The email client is configured to retrieve the members of that email alias together with a public encryption key for each of the members, generate a session key for the email, then encrypt the session key with each of the public keys and send the encrypted email to each of the members of the email alias.

### TECHNICAL FIELD

This application relates to apparatus and methods for processing outgoing electronic communications, and in particular to apparatus and methods for interaction between message groups and encryption methods.

### BACKGROUND

Exchanging electronic communications amongst users across a network has enabled much more efficient business processes then ever before. Users are not restricted to collaborating with other users in the same office. Now they can collaborate with users in different buildings, different cities, and even different countries.

Telecommuting is just one tool that businesses use to enable their employees to work more flexible schedules. One method of enabling those employees to work remotely is to create an encrypted network connection between their home office and the corporate network. In other words, the computer in their home office is essentially on the corporate network. They have access to all of the corporate network resources, even though they may be thousands of miles away.

However, as computer users begin to collaborate outside the corporate context, the ability to operate on the corporate network as if you were there becomes less compelling as these users are now working for different companies and are connected to different corporate networks. Exchanging communications in a secure, encrypted way decentralizes work past just merely telecommuting into a new paradigm of work and collaboration.

### BRIEF DESCRIPTION OF DRAWINGS

Embodiments of the present invention are illustrated by way of example and not limitation in the figures of the accompanying drawings, in which like references indicate similar elements and in which:

FIG. 1A shows an architecture of a client apparatus to process an electronic communication, in accordance with an example embodiment;

FIG. 1B shows a more detailed architecture of the client apparatus in FIG. 1A, in accordance with an example embodiment;

FIG. 2 shows a flow diagram of a method of processing an electronic communication, in accordance with an example embodiment;

FIG. 3 shows a flow diagram of a method of processing a message at a recipient, in accordance with an example embodiment;

FIG. 4 shows architecture of a system of processing and delivering of an electronic communication, in accordance with an example embodiment;

FIG. 5 shows a data-flow diagram of a method of processing and delivering of an electronic communication received at an electronic message client, in accordance with an example embodiment;

FIG. 6A shows an architecture of a server apparatus to process a message at a recipient, in accordance with an example embodiment;

FIG. 6B shows a more detailed architecture of a server apparatus in FIG. 6A, in accordance with an example embodiment; and

FIG. 7 shows a block diagram of a machine including instructions to perform any one or more of the methodologies described herein.

### DETAILED DESCRIPTION

In an example embodiment, a method and a system to process an outgoing electronic communication is described.

In the following detailed description of example embodiments, reference is made to the accompanying drawings, which form a part hereof, and in which is shown, by way of illustration, specific embodiments where the example method, apparatus and system may be practiced. It is to be understood that other embodiments may be utilized, and structural changes may be made, without departing from the scope of this description.

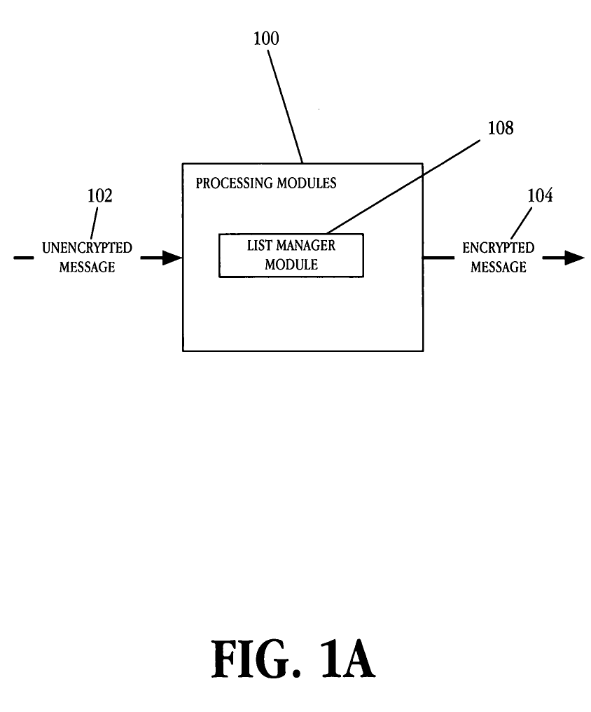

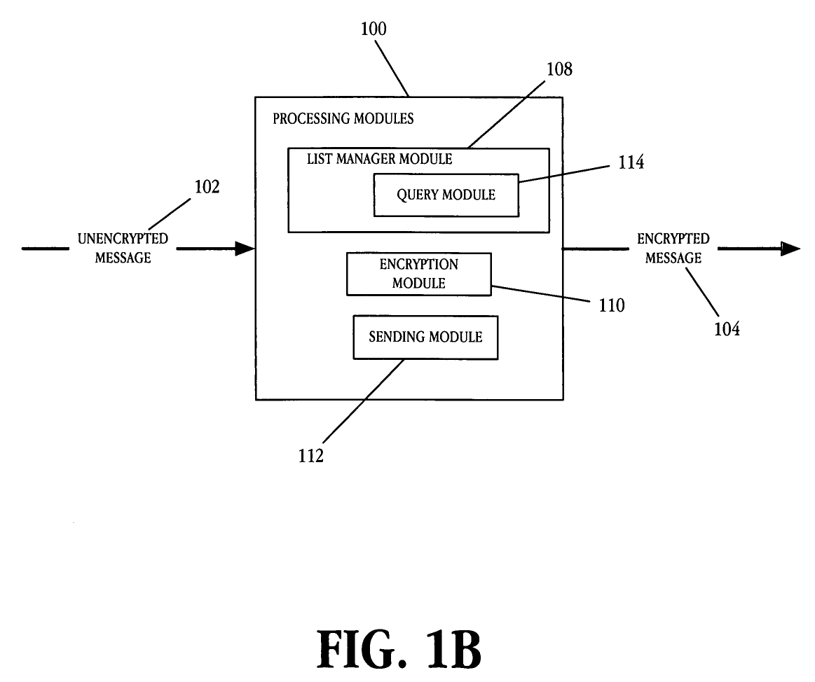

FIG. 1A shows architecture of a client apparatus to process an electronic communication, in accordance with an example embodiment. The client apparatus 100 receives an unencrypted message 102 as an input and outputs an encrypted message 104. The unencrypted message 102 is addressed to a message recipient, the message recipient denoting the intended destination of the message. The unencrypted message 102 may be addressed to more than one recipient. The client apparatus 100 comprises one or more processing modules, including a list manager module 108.

In an embodiment, the unencrypted message 102 is received as an input at the client apparatus 100. One example of such receipt is a user of the client apparatus 100 sending an email message, the email message received by the client apparatus 100 as the input. The unencrypted message 102 is addressed to a message recipient. The message recipient, by way of example, is an intended receiver of the unencrypted message and may be denoted by an email address (such as user@domain.com) or a network address (such as 127.0.0.1 or host.domain.com). These examples are only illustrative and any data item used to denote the message recipient or an electronic address of the message recipient or the recipient is considered to the within the scope of the present application. The message recipient may also include a message group, the group denoting more then one member such that a communication addressed to the message group is sent to an electronic address for each of the members of that group.

The client apparatus 100 encrypts the unencrypted message 102 using an encryption mechanism for each of the message recipients. Encryption mechanisms, by way of example, may include encryption methods, such as public-key infrastructure (PKI) cryptography, symmetric key cryptography, use of encryption certificates or any suitable method of encrypting an electronic communication. Some examples of public-key cryptography include Pretty Good Privacy (PGP) and GNUPg. In the context of the present discussion, any suitable method of end-to-end encryption is considered to be within the scope of the present application. End-to-end encryption takes place at a layer higher then the physical layer, as defined by the Open Systems Interconnection (OSI) network module. Usage of such encryption methods provides the advantage of being extremely secure from user to user, without requiring the configuration of any network devices between them. Though mention is made of specific encryption mechanisms, this is not meant to be limiting in any manner, and any method of encrypting a message using an individual recipient's encryption mechanism is considered within the scope of the present application. The client apparatus 100, using the encryption mechanism of the message recipients, encrypts the message 102 and outputs the encrypted message 104.

In an embodiment, the unencrypted message 102 is encrypted with a single session key, and this session key is encrypted for each of the individual message recipient's encryption mechanisms. In such an embodiment, a single encrypted email is sent to more than one message recipient, the single encrypted email capable of being unencrypted by each of the message recipients. In such an example, the encrypted email is sent along with a separate data item for each of the message recipients, the separate data item including the session key encrypted with that message recipient's public key. Upon receipt of the encrypted message, the message recipient uses their private key to decrypt the session key, and then uses the session key to decrypt the actual content of the email message.

In an embodiment, the list manager module 108 is configured to maintain a detailed listing of message groups and message recipients associated with the message groups together with an encryption mechanism for each of the message recipients. Detailed listing includes, without limitation, a listing of each member of a message group together with a message address associated with the member, an itemized listing of members of a message group and addresses, an enumerated listing of members of a message group and addresses, and the like.

In an embodiment, the list manager module 108 maintains a local data store of message recipients and encryption mechanisms. In an alternate embodiment, the list manager module 108 is configured to query a server, which is external to the client apparatus 100. In such an example, the list manager module 108 queries for members of a message group and encryption mechanisms for each of the members of the message group. In yet another embodiment, the list manager module 108 periodically queries a server for a detailed listing of message groups stored on the server and members of those message groups. The list manager module 108, in this example, additionally checks for encryption mechanisms for each of the members of those message groups. In such an embodiment, the list manager module 108 locally maintains an updated listing of member groups, members and encryption mechanisms, without being continually coupled to the server.

In an embodiment, the list manager module 108 is configured to maintain an association between message groups and message recipients. In such an example, the unencrypted message 102 is addressed to a single recipient, the message group. Alternately, the unencrypted message 102 is addressed to more than one message group. The list manager module 108 is configured to take the message group, determine members of the message group, and address the message to each of the members of the message group. In an example embodiment, the list manager module 108 maintains an encryption mechanism for each of the members in the message group. The list manager module 108, in this example, upon retrieving the members of the message group also retrieves an encryption mechanism for each of the message recipients. The client apparatus 100, using both the address of the member and the encryption mechanism associated with the member, is configured to encrypt the message and send the encrypted message to the member of the message group.

FIG. 1B shows a more detailed architecture of the client apparatus in FIG. 1A to process an electronic communication. In an embodiment, the processing modules include a list manager module 108, an encryption module 110 and a send module 112.

The list manager module 108 includes a query module 114 configured to query a server external to the client apparatus for message groups, members of message groups, and encryption mechanisms for each of the members. In one embodiment, the query module 114 is contained within the list manager module 108 as shown in FIG. 1B. Alternately, the query module 114 is coupled to the list manager module, but is not contained within the list manager module 108. In an embodiment, the query module 114 is configured to query a data store maintained by the list manager module 108. The data store may be stored locally on the messaging client apparatus 100. The data store, in such an example, includes one or more message groups, a detailed listing of the members of the message groups, and at least one encryption mechanism for the members.

The client apparatus 100 is also shown to include an encryption module 110. The encryption module 110 is configured to receive an unencrypted data item and encrypt it using any suitable encryption mechanism. The client apparatus 100 also includes a send module 112 configured to send the encrypted message 104 to the members of the message group using any suitable communications protocol, such as simple mail transfer protocol (SMTP).

Reference is made, inter alia, herein to messages, message groups, and message recipients. Message, as used in the present application, may include, without limitation, email messages, instant messages, text messages, Voice-over-IP (VOIP) messages, or any communication that is capable of being sent from one user to another user, group of users, or some combination of both, over any suitable communications network that is capable of being encrypted. Though reference is made to a user, it will be understood that the apparatus and methods described herein have equal applicability to any content delivered to one or more users such as distribution of encrypted multimedia content. The sending entity may be an automated delivering system, and is considered to be a user within the context of the present discussion. Messages also include digital files, multimedia content, or any other data item containing information, where more than one user is capable of downloading that file. The server making such files available is considered to be the messaging client and sends a communication containing those files to the end-user. In such a context, the server may maintain a listing of which end-users are subscribed to that content and can encrypt that content for all of them, preventing unauthorized end-users from accessing that content.

Additionally, software applications exist that allow an end user to aggregate content from many sources periodically. These applications retrieve new content from a server entity on their own initiative, and make that new content available for the user. Delivery of electronic communications through such a mechanism is still to be considered within the scope of the present discussion. In such an example, the server entity is configured to encrypt the content with one or more encryption mechanisms for each user that is subscribed to such content. One example of such an aggregator is a Really Simple Syndication (RSS) aggregator, though mention here is only illustrative and any other mechanism that is configured to aggregate content from a server entity, where the server entity has a group of recipients that has subscribed to such content, is considered to be within the scope of the present discussion.

A client apparatus 100 has been described along with its associated functions with respect to FIGS. 1A and 1B. Methods of processing an unencrypted message 102 using the client apparatus 100 can now be discussed in more detail.

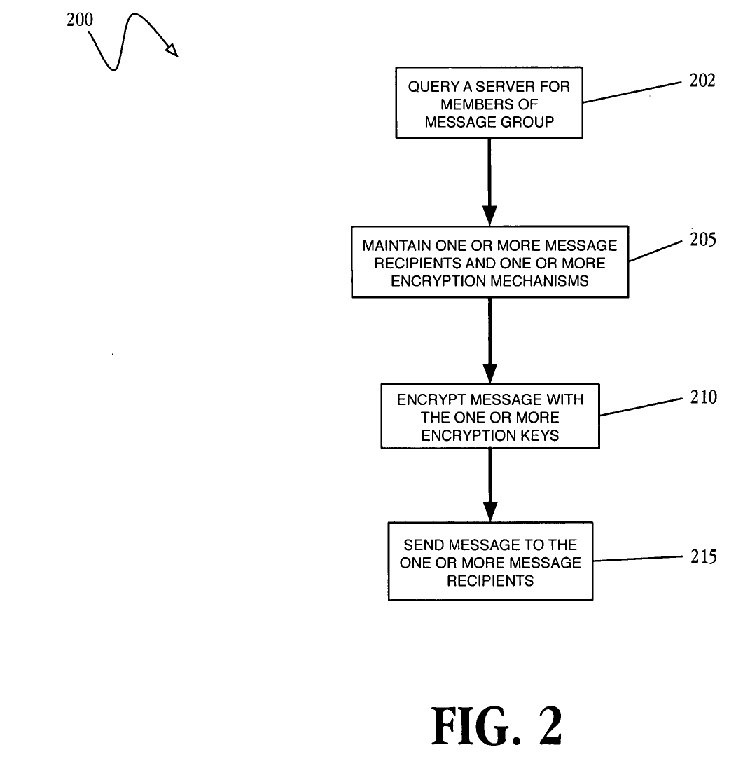

FIG. 2 shows a flow diagram of a method 200 of processing an electronic communication, in accordance with an example embodiment. In an embodiment, the method 200 is described with respect to FIG. 2 and may be carried out on a client apparatus 100 as described above with respect to FIGS. 1A and 1B. The operations depicted in FIG. 2 may be carried out when a message is sent to a message group. For example, a user may compose an email message which is to be sent to a group of recipients. For example, the user may select an email alias including email addresses of all members of the group. In an embodiment, instead of sending the email message to a server, where the alias is identified, and then sending the message to the individual members, individual email addresses in the alias and encryption information associated with each email address are downloaded onto the client apparatus 100. Accordingly, as shown at block 202, the method 200 may include querying (e.g., periodically) a server to obtain or update members of message group (e.g., email addresses of an email alias). Likewise, encryption information associated with each email address may be obtained. Thus, as shown at block 205, one or more message recipients and their corresponding encryptions mechanism/information may be maintained on the client apparatus 100.

In one embodiment, the encryption mechanism is requested after the message recipients are received. In an alternate embodiment, the encryption mechanism is received along with the message recipients.

At block 210, the message is encrypted using the one or more encryption mechanisms. In one embodiment, one encryption mechanism for each of the message recipients is used. In another embodiment, more than one encryption mechanism for one or more of the message recipients is used for to encrypt the message. In yet another embodiment, encrypting the message using the one or more encryption mechanisms includes using all of the encryption mechanisms requested after the message recipients are received or all of the encryption mechanisms received along with the message recipients. In such an example, more then one encryption mechanism is used to encrypt the message. As provided for by the PGP encryption method, for example, the message may be encrypted with multiple encryption mechanisms. It will be appreciated that any suitable encryption method may be used. For the purposes of illustration, reference is made here to PGP encryption methods, though this is not meant to be limiting in any manner. The message may be encrypted using a single-use session key. The single-use session key may then be encrypted multiple times using each of the individual encryption mechanisms for each of the one or more message recipients.

At block 215, the encrypted message is sent to the one or more message recipients. In an example embodiment, each message recipient associated with the message group has an encryption mechanism capable of decrypting the message. In an alternate embodiment, one or more of the message recipients lack an encryption mechanism. In such an example, the message may be encrypted as previously discussed and sent to all message recipients including the message recipients that lack an encryption mechanism. For those recipients lacking an encryption mechanism, the encrypted message cannot be decrypted, retaining the security of the message content. Alternately, the message can be sent in without encryption to those recipients that lack an encryption mechanism.

In an alternate embodiment, the operations described with respect to block 205 occur following a query for members of a message group at block 202. At block 202, the client apparatus 100 queries a server for members of a message group when the client apparatus sends a message addressed to at least one message group. In one embodiment, the client apparatus 100 periodically queries the server at block 202 for members of a message group and in response to the query receives members associated with the message group together with an encryption mechanism for each of the members. By receiving the members together with their encryption mechanisms, in this example, the client apparatus 100 is able to maintain one or more message recipients together with encryption mechanisms at the client apparatus 100. In an alternate embodiment, the client apparatus 100 queries the server for members of a message group at block 202 before sending a message, such that the user selecting send in the message client initiates the operations depicted in FIG. 2. In such an example, the operations at block 205 can be omitted.

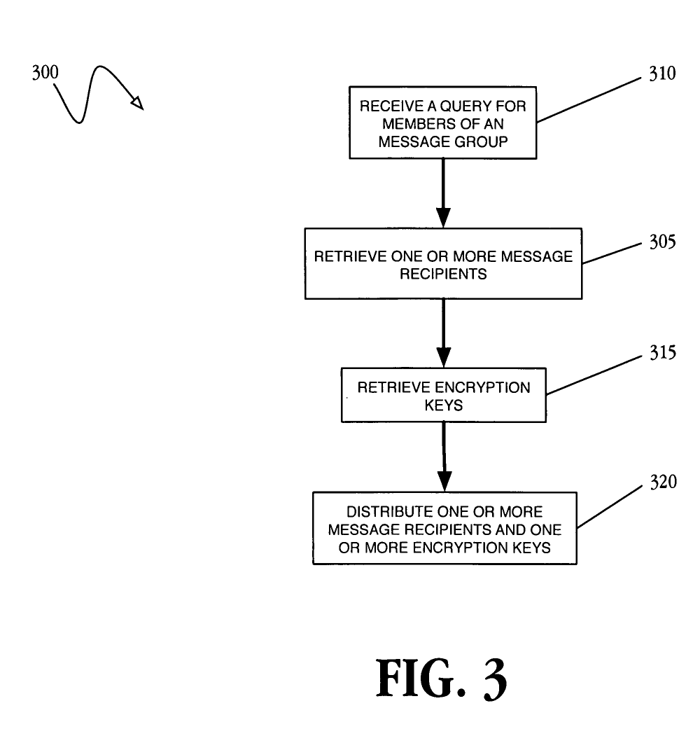

As described here, some of the operations with respect to FIG. 2 may involve the use of a server that is communicatively coupled to the client apparatus 100. Operations on the server are discussed now with respect to FIG. 3.

FIG. 3 shows a flow diagram of a method 300 of processing a message at a recipient, in accordance with an example embodiment. In an embodiment, the message addressee is a message group. In an embodiment, the operations depicted in FIG. 3 and described herein are carried out on a server coupled to the client apparatus 100 described above.

At block 305, the server retrieves a plurality of recipient addresses associated with a message group. In an embodiment, the server periodically determines message groups supported by the server, and retrieves one or more message recipients associated with the message groups. The server may repeat the operations at block 305 for each message group. Alternately, the server may be first queried by a client at block 310 for members of a message group. The server may retrieve at block 305 email addresses of the members of the message group received at block 310.

At block 315, the server retrieves one or more encryption keys, at least one encryption key for each of the members of the message group. In the example where the operations at block 305 are repeated for more than one message group, the operations at block 315 would also be repeated. In the example where a single message group is received as a query at block 310, only the encryption keys for the members associated with that single message group are retrieved at block 315.

At block 320, the members of the message group and encryption mechanisms for each of the members are packaged and distributed. In one embodiment, where the server periodically polls for all supported message groups, the package contains the members of each message group together with an encryption mechanism for each of those members. The package is then distributed through any suitable means to clients coupled to the server. Coupling may include, without limitation, clients on the same local network segment, clients across a local area network where the server is configured through any suitable means to provide updates to the clients, or clients across a wide area network where the server is configured through any suitable means to provide updates to the clients.

In another embodiment, the server packages the members of the message group, together with an encryption mechanism for each of the members, received as a query from a client at block 310 and distributes that package at block 320 to the client.

In an alternate embodiment, the server is queried at block 310 for changes in the members of the message group. In such an example, only additional members together with an encryption mechanism for each of them is packaged and distributed at block 320. Additional members, in the context of the present application, may include members who were not members of the message group when the client first queried for the members at some time previous to the present operations, or members who were not members of the message group when the client received a periodic update distribution package of members of message groups together with encryption mechanisms.

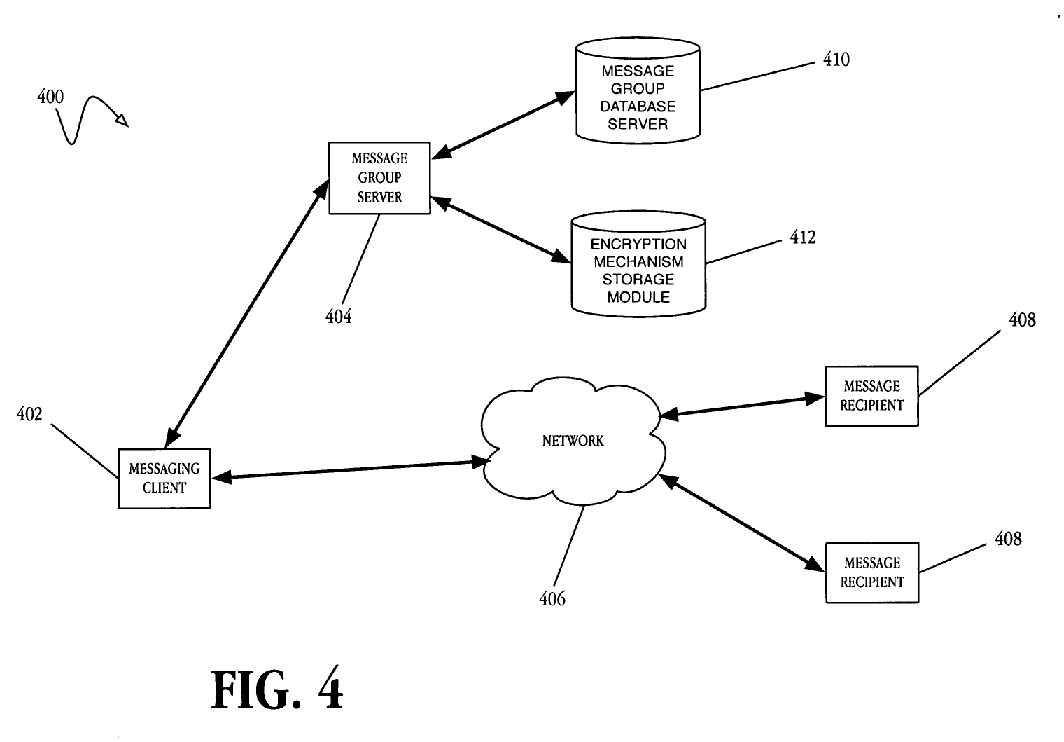

Methods of operation for the client apparatus 100 and a server to process an electronic communication have been described. Discussion can now turn to a system of clients and servers that employ these methods, as depicted by way of example in FIG. 4.

FIG. 4 shows architecture of a system of processing and delivering of an electronic communication, in accordance with an example embodiment. The system 400 is shown to comprise a messaging client 402, a message group server 404, a network 406 and message recipients 408. In a further embodiment, the message group server 404 is coupled to one or more data stores. The data stores may include a message group database server 410 and an encryption mechanism storage module 412.

The messaging client 402 provides a user the ability to draft messages and send those messages to one or more recipients. The one or more recipients may be a group of recipients. The group may contain one or more members, each member having one or more message address associated with them. The messaging client 402 may receive a send command from the user and the message is then sent to the recipients. The messaging client 402 may take the message group as the addressee, determine the members of the message group, retrieve the encryption mechanism for each of the members, encrypt the message using the encryption mechanism and send the message. In an example embodiment, the messaging client 402 maintains a listing of message groups, members of the message groups and encryption mechanisms. In such an example, the message client may query a message group server 404 periodically for updates for the maintained listing. In another embodiment, the messaging client 402 queries the message group server 404 whenever a message is sent to a message group.

The message group server 404 packages and distributes to the messaging client 402 the members of one or more message groups together with an encryption mechanism for each of the members. In one embodiment, the message group server 404 responds to queries from the messaging client 402. In an alternate embodiment, the message group server 404 broadcasts to the messaging client 402. The message group server 404 is coupled to data stores that store message groups, members associated with those message groups and encryption mechanisms for each of the members. As depicted in FIG. 4, each of the data stores may be separately coupled to the message group server 404, though this is not meant to be limiting in any manner as the data stores may be combined into a single data store. Additionally, the information contained in the data stores may be stored on the message group server 404.

Following the encryption of the message at the messaging client 402, the message is sent using any suitable method and sent over any suitable network to one or more clients 408.

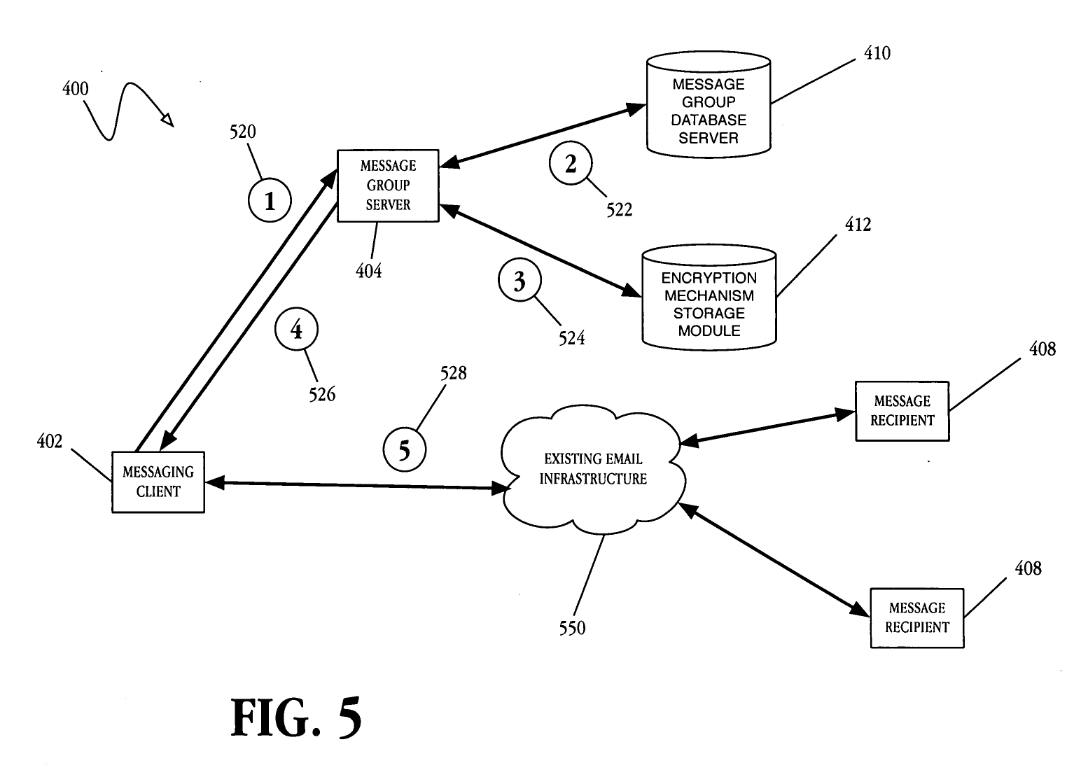

FIG. 5 shows a data-flow diagram of a method of processing and delivering of an electronic communication received at an electronic message client, in accordance with an example embodiment. In an embodiment, the data-flow-diagram is carried out in a system 400 such as that described above with respect to FIG. 4. In such an example, a user of the messaging client 402 is sending an encrypted message to one or more message recipients 408.

The messaging client 402 sending a message to one or more recipients 408 accesses, or in an alternative operation, queries 520 the message group server 404, for the members of the message group and an encryption mechanism for each of the members. In the alternative example, the message group server 404 retrieves the members of the message group and the encryption mechanisms from one or more data stores. In one example, the message groups, members, and the association between members and message groups, is maintained on a message group database server 410. In such an example, the encryption mechanisms for each of the members is stored on an encryption mechanism storage module 412 and the message group server 404 separately queries 522 the message group database server 410 and queries 524 the encryption mechanism storage module 412. In another example, the data stored on the message group database server 410 is stored along with the encryption mechanisms contained in the encryption mechanism storage module 412 on a single data store. In yet another example, the data stores are contained along with the message group server 404.

In the example where the messaging client 402 queries 520 the message group server 404 for the members and their encryption mechanisms, the messaging client 402 receives 526 a package response from the message server. The package response may contain a message group, the members of the message group, and an encryption mechanism for each of the members.

In one example embodiment, the operations to query the message group server 404 and receive a packaged response occur periodically without regard to a present need to send a message. Through such a mechanism, the messaging client 402 can maintain one or more message groups, a detailed listing of the members of the message group and one or more encryption mechanisms for each of the members. One advantage of such an approach is that the messaging client 402 need not delay sending a message waiting for other operations to occur. Alternately, the message group server 404 can periodically update one or more messaging clients 402 with updated detailed listings of the members of supported message groups together with the encryption mechanisms for each of the members. One advantage of this type of approach is that the messaging client 402 maintains an updated listing. The approach depicted with the operations above is that the messaging client 402 always queries the message group server 404. The advantage of this approach is that the members of the message group sent in the package response are always complete and up to date.

Without regard to the mechanism by which the messaging client 402 receives the members of the message group and the encryption mechanisms, the messaging client 402 encrypts the message using the encryption mechanisms as discussed above and sends 528 the message using any suitable communications network, such as an existing email infrastructure 550, to the members of the message group, the message recipients 408.

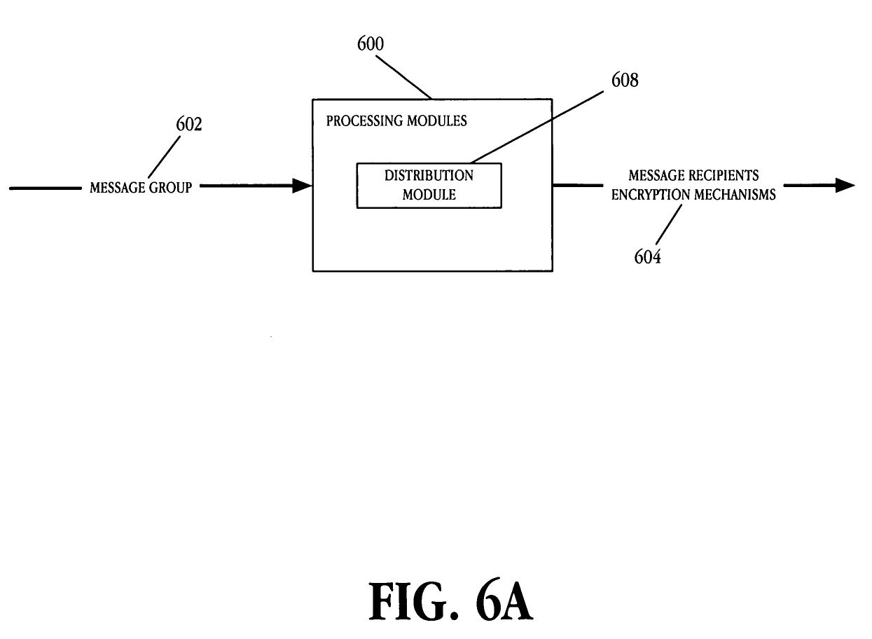

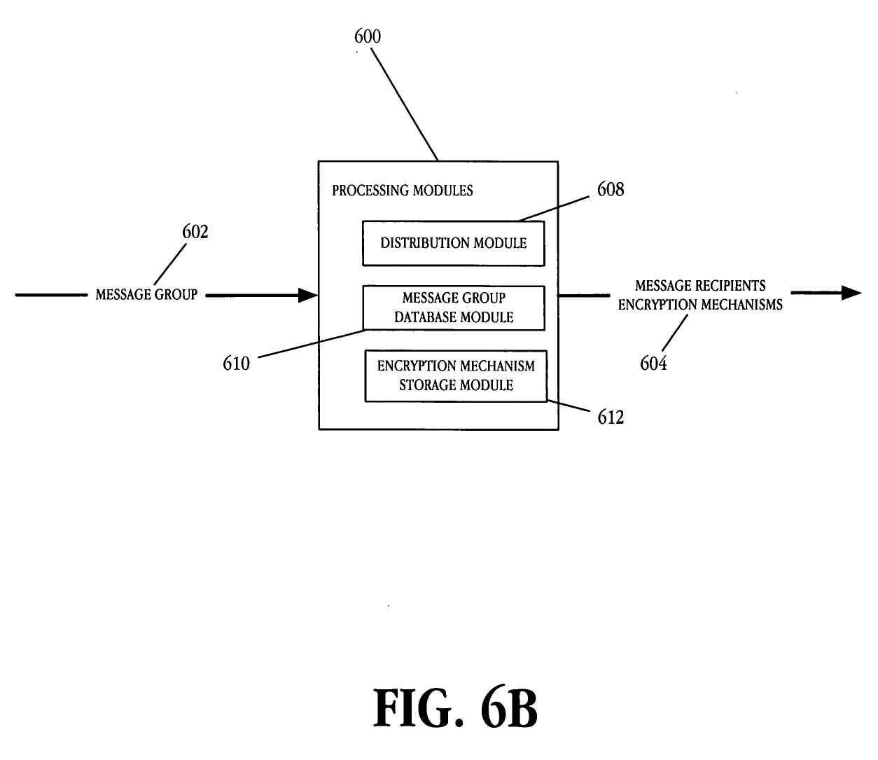

Reference has been made to a server with respect to the operations and apparatus already described. A server, such as that previously discussed, is described in more detail by way of example with respect to FIGS. 6A and 6B.

FIG. 6A shows architecture of a server apparatus to process a message recipient, in accordance with an example embodiment. In an embodiment, the server apparatus 600 processes message groups 602 and packages one or more message recipients associated with the message group and an encryption mechanism for each of the one or more message recipients 604. The server apparatus 600 includes one or more processing modules. In an embodiment, the processing module is a distribution module 608.

The distribution module 608 provides addresses of message recipients associated with the message group received by the server apparatus as an input, together with at least one encryption mechanism for each of the message recipients. In one embodiment, the distribution module 608 of the server apparatus responds to a request for members of a message group and encryption mechanisms for each of the members. In an alternate embodiment, the distribution module 608 periodically packages message recipients and encryption mechanisms for the message recipients along with associations between those message recipients and one or more message groups. In such an example, the client apparatus 100, as shown in FIGS. 1A and 1B and described above, periodically receives that information and maintains it locally. Through such a mechanism, the client need not query the server whenever sending a message addressed to at least one message group.

FIG. 6B shows a more detailed architecture of a server apparatus in FIG. 6A, in accordance with an example embodiment. In a further embodiment, the one or more processing modules additionally include a message group database module 610 and an encryption mechanism storage module 612.

The message group database module 610 stores associations between message groups and message addresses of the members of the message groups. By way of example, a query sent to the message group database module 610 containing a message group may return a listing of the members of the message group and the message addresses of the members of the message group. In one embodiment, the distribution module queries the message group database module 610 for the members of a message group. In a further embodiment, the distribution module 610 is further configured to retrieve one or more encryption mechanisms for each of the members from an encryption mechanism storage module 612. In an alternate embodiment, the functions of the message group database module 610 and the encryption mechanism storage module 612 are combined in a single data store, such that the distribution module 608 queries that single data store and receives in reply a single package containing the members of the message group together with at least one encryption mechanism for each of the members. In another embodiment, the functions of the message group database module 610 and the encryption mechanism storage module 612 are contained within the distribution module 608. In such an example, response times to queries from clients and network traffic may be reduced.

In an embodiment, the distribution module 608 is configured to periodically poll the message group database module 610 for members of message groups supported by the message group database module. The distribution module 608 is further configured to retrieve one or more encryption mechanisms for each of the members of the message group. In such an example, the distribution module 608 would step through each of the message groups, receiving a listing of the members and then retrieving the encryption mechanisms for those members. In an alternate embodiment, the distribution module 608 receives all members supported by the message group database module 610 and the message groups they are associated with.

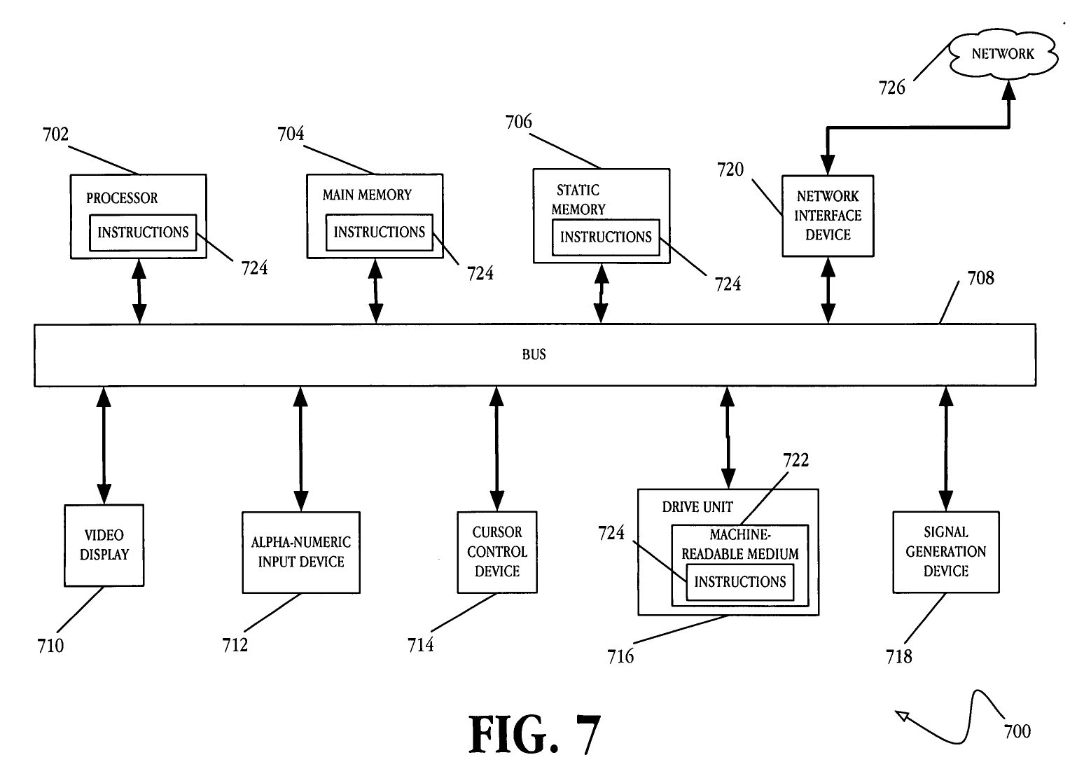

FIG. 7 shows a block diagram of a machine including instructions to perform any one or more of the methodologies described herein. In an embodiment a computer system 700, within which a set of instructions for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a voice mail system, a cellular telephone, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), optionally cursor control device 714 (e.g., a mouse), optionally a disk drive unit 716, a signal generation device 718 (e.g., a speaker) and a network interface device 720.

The disk drive unit 716 includes a machine-readable medium 722 on which is stored one or more sets of instructions and data structures (e.g., software instructions) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

The instructions 724 may further be transmitted or received over a network 726 via the network interface device 720 utilizing any one of a number of transfer protocols (e.g., HTTP).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such medium may also include, without limitation, hard disks, floppy disks, flash memory cards, digital video disks, random access memory (RAM), read only memory (ROMs), and the like.

The embodiments described herein may be implemented in an operating environment comprising software installed on any programmable device, in hardware, or in a combination of software and hardware.

Although embodiments have been described with reference to specific example embodiments, it will be evident that various modifications and changes may be made to these embodiments without departing from the broader spirit and scope of the invention. Accordingly, the specification and drawings are to be regarded in an illustrative rather then a restrictive sense.

1. A method of processing an electronic communication addressed to at least one message group, comprising:
identifying a plurality of message recipients associated with the at least one message group and an encryption mechanism for each of the message recipients;
at a client device, encrypting the electronic communication with the encryption mechanisms for each of the message recipients; and
sending the encrypted electronic communication to the message recipients.

2. The method of claim 1, further comprising:
retrieving a list of message recipients from a dynamically maintained remote data store, the list of message recipients being associated with the message group together with an encryption mechanism for each of the message recipients.

3. The method of claim 2, wherein the remote date store is dynamically maintained.

4. The method of claim 1, wherein identifying a plurality of message recipients associated with at least one message group and an encryption mechanism for each of the message recipients comprises:
querying a server for a list of message recipients associated with the message group and the encryption mechanism for each of the message recipients; and
receiving from the server one or more message recipients associated with the message group and the encryption mechanism for each of the one or more message recipients.

5. The method of claim 1, wherein the encryption mechanism includes at least one of the following: public-key encryption, symmetric key encryption, encryption certificate.

6. A machine-readable medium embodying instructions which, when executed by a machine, causes the machine to perform the method of claim 1.

7. Apparatus to process outgoing electronic communications addressed to at least one message group, comprising:
a list manager module to maintain a list of message recipients associated with a message alias together with at least one encryption mechanism for each of the message recipients.

8. The apparatus of claim 7, wherein the list manager module includes:
a query module to query a server for the list of message recipients associated with the message alias and at least one encryption mechanism for each of the message recipients.

9. The apparatus of claim 8, further comprising:
an encryption module to encrypt a message, the message addressed to the message alias, using the at least one encryption mechanism for each of the message recipients associated with the message alias.

10. The apparatus of claim 8, further comprising a sending module to send the encrypted message to the message alias.

11. A method of distributing members of a message group to one or more messaging clients, comprising:
retrieving from a data store one or more message recipients associated with a message group and at least one encryption mechanism for each of the one or more message recipients; and
distributing to the messaging client the one or more message recipients associated with the message group together with the encryption mechanism for each of the one or more message recipients.

12. The method of claim 11, further comprising:
receiving a query from a messaging client, the query containing a request for the one or more message recipients associated with the message group.

13. The method of claim 12, wherein the query is received prior to retrieving from the data store one or more message recipients and the at least one encryption mechanisms.

14. The method of claim 11, wherein the encryption mechanism is a public-key infrastructure encryption mechanism.

15. The method of claim 14, wherein the encryption key is a public-key of a public-private key pair.

16. The method of claim 11, wherein the encryption mechanism is an encryption certificate.

17. A machine-readable medium embodying instructions which, when executed by a machine, causes the machine to perform the method of claim 11.

18. Apparatus to distribute members of a message group to one or more messaging clients, comprising:
a distribution module to distribute to a messaging client a list of message recipients associated with a message group and an encryption mechanism for each of the message recipients.

19. The apparatus of claim 18, further comprising:
a message group database module to store:
one or more message groups:
one or more message addresses, each of the one or more message addresses associated with a message recipient; and
associations between the one or more message recipients and the one or more message groups; and
an encryption mechanism storage module to store one or more encryption mechanisms for each of the one or more message recipients.

20. Apparatus for processing electronic communications addressed to at least one message group, comprising:
means for identifying a plurality of message recipients associated with the at least one message group and an encryption mechanism for each of the message recipients;
means for encrypting the electronic communication with each encryption mechanism; and
means for sending the encrypted electronic communication to the message recipients.

21. The apparatus of claim 20, further comprising:
means for retrieving a list of message recipients includes retrieving from a dynamically maintained remote data store, the list of message recipients being associated with the message group together with an encryption mechanism for each of the message recipients.

22. The apparatus of claim 21, wherein the remote date store is dynamically maintained.

23. The apparatus of claim 20, wherein retrieving an enumerated list includes:
querying a server for a list of message recipients associated with the message group together with the encryption mechanism for each of the message recipients; and
receiving from the server one or more message recipients associated with the message group together with the encryption mechanism for each of the one or more message recipients.

24. The apparatus of claim 20, wherein the encryption mechanism includes at least one of the following: public-key encryption, symmetric key encryption, encryption certificate.
